(19) United States
(12) Patent Application Publication
(10) Pub. No.: US 2026/0038974 A1
(43) Pub. Date: Feb. 5, 2026

(54) ELECTRIC POTENTIAL APPLIED TO BATTERY ENCLOSURE

(71) Applicant: GM GLOBAL TECHNOLOGY OPERATIONS LLC, Detroit, MI (US)

(72) Inventors: Mark Daniel Gottlieb, Royal Oak, MI (US); Dillon T. Carden, Shelby Twp, MI (US); Seung-woo Chu, Sterling Heights, MI (US)

(73) Assignee: GM GLOBAL TECHNOLOGY OPERATIONS LLC, Detroit, MI (US)

(21) Appl. No.: 18/793,150

(22) Filed: Aug. 2, 2024

(51) Int. Cl. H01M 50/48; B60L 50/64; H01M 50/103; H01M 50/474; H01M 50/55

(52) U.S. Cl. CPC H01M 50/48; B60L 50/64; H01M 50/103; H01M 50/474; H01M 50/55; H01M 2220/20

(57) ABSTRACT

Battery assemblies, vehicle with battery assemblies, and methods for applying potential to battery enclosures are provided. A method includes enclosing a first electrode and a second electrode within an enclosure; electrically connecting the first electrode to a first terminal; electrically connecting the second electrode to a second terminal; locating an insert between the electrodes and the enclosure, wherein the insert includes a conductive region electrically connecting the first electrode to the enclosure, and wherein the insert includes an insulative region electrically insulating the first electrode from the enclosure; and establishing an electrical connection from the from the first electrode through the conductive region, wherein the electrical connection is configured to apply a potential to the enclosure.

### INTRODUCTION

The disclosure relates to motor vehicle battery systems, and more specifically to devices and methods for applying an electric potential to a battery enclosure.

A battery includes at least one pair of an anode electrode and a cathode electrode and includes a separator disposed between the anode electrode and the cathode electrode. Each of the anode electrode and the cathode electrode includes or is formed upon a current collector which may be a conductive metal piece utilized to conduct electrical energy from the respective electrode to a battery terminal. The anode electrode is connected to a negative battery terminal, and the cathode electrode is connected to a positive battery terminal. A battery may include a can or an outer rigid housing or enclosure useful to contain and protect the electrodes and separator. The enclosure may be constructed of a metal.

An electrode assembly may include one or more electrode pairs. According to one embodiment, the electrode assembly may include a plurality of alternating flat electrodes. According to another embodiment, the electrode assembly described as a jellyroll electrode assembly or multiple jellyroll electrode assemblies. Each jellyroll electrode assembly may include a single flexible pair of electrodes, with the electrodes rolled into a cylindrical or a flattened cylindrical shape. A jellyroll electrode assembly includes a separator layer, a cathode layer, an inert laminate layer, and an anode layer. Viewing an end of the jellyroll electrode assembly, the layers may appear as a swirl, with the anode layer and the cathode layer separated by the separator layer. The anode layer may be connected to a negative battery terminal through a first current collector, and the cathode layer may be connected to a positive battery terminal through a second current collector.

Corrosion of the metal enclosure may be prevented or delayed by applying an electric potential to the enclosure. When the metallic enclosure of the battery cell does not have a proper electrochemical potential, corrosion of the metallic enclosure may occur and may eventually cause electrolyte leakage, which is harmful to occupants and causes deterioration of the battery cell performance significantly.

Accordingly, there is a need for devices and methods for applying a selected electric potential to a battery enclosure. Furthermore, other desirable features and characteristics of the present disclosure will become apparent from the subsequent detailed description and the appended claims, taken in conjunction with the accompanying drawings and the foregoing technical field and background.

### SUMMARY

An embodiment provides a method including enclosing a first electrode and a second electrode within an enclosure; electrically connecting the first electrode to a first terminal; electrically connecting the second electrode to a second terminal; locating an insert between the electrodes and the enclosure, wherein the insert includes a conductive region electrically connecting the first electrode to the enclosure, and wherein the insert includes an insulative region electrically insulating the first electrode from the enclosure; and establishing an electrical connection from the from the first electrode through the conductive region, wherein the electrical connection is configured to apply a potential to the enclosure.

In certain embodiments, the method further includes forming the insert by adding a conductive additive to a plastic resin.

In certain embodiments of the method, the conductive region is comprised of up to 30% of the conductive additive by weight.

In certain embodiments, the method further includes electrically connecting, through a first connector, the first electrode to the first terminal; and abutting the conductive region with the enclosure and with the first connector.

In certain embodiments of the method, the conductive additive includes carbon black.

In certain embodiments, the method further includes electrically connecting, through a first connector, the first electrode to the first terminal; and abutting the conductive region with the enclosure, with the first connector, and with the first electrode.

In certain embodiments of the method, the insert is deformable, and locating the insert between the electrodes and the enclosure includes deforming the insert.

In another embodiment, a battery assembly includes an enclosure surrounding an internal space; a first electrode located in the internal space; a second electrode located in the internal space; a first connector in electrical connection with the first electrode and extending out of the enclosure to a distal end; a second connector in electrical connection with the second electrode and extending out of the enclosure to a distal end; a first terminal in electrical connection with the distal end of the first connector; a second terminal in electrical connection with the distal end of the second connector; a conductive region electrically connecting the first electrode to the enclosure and configured to apply a potential to the enclosure; and an insulative region electrically insulating the first electrode from the enclosure.

In certain embodiments of the battery assembly, the conductive region includes a conductive tape segment adhered to the insulative region.

In certain embodiments of the battery assembly, the battery assembly includes an insert located between the enclosure and the electrodes, the insert is deformable, and the insert includes the conductive region electrically connecting the first electrode to the enclosure and the insulative region.

In certain embodiments of the battery assembly, the conductive region of the insert includes a plastic resin and a conductive additive.

In certain embodiments of the battery assembly, the conductive region of the insert includes a plastic resin and a conductive additive, and the conductive region is comprised of up to 30% of the conductive additive by weight.

In certain embodiments of the battery assembly, the conductive additive includes carbon black.

In certain embodiments of the battery assembly, the conductive region abuts the enclosure and the first connector, abuts the enclosure and the first electrode, or abuts the enclosure, the first connector, and the first electrode.

In another embodiment, a vehicle includes an electric motor configured to provide motive torque; and a battery system operatively connected to the electric motor and operable to provide electrical power to the electric motor, wherein the battery system includes an enclosure surrounding an internal space; a first electrode located in the internal space; a second electrode located in the internal space; a first connector in electrical connection with the first electrode and extending out of the enclosure to a distal end; a second connector in electrical connection with the second electrode and extending out of the enclosure to a distal end; a first terminal in electrical connection with the distal end of the first connector; a second terminal in electrical connection with the distal end of the second connector; and an insert located between the enclosure and the electrodes, wherein the insert includes a conductive region electrically connecting the first electrode to the enclosure and configured to apply a potential to the enclosure, and wherein the insert includes an insulative region electrically insulating the first electrode from the enclosure.

In certain embodiments of the vehicle, the conductive region of the insert includes a plastic resin and a conductive additive.

In certain embodiments of the vehicle, the conductive region is comprised of up to 30% of the conductive additive by weight.

In certain embodiments of the vehicle, the conductive additive includes carbon black.

In certain embodiments of the vehicle, the conductive region abuts the enclosure and the first connector.

In certain embodiments of the vehicle, the conductive region abuts the enclosure and the first electrode.

### DESCRIPTION OF THE DRAWINGS

The present disclosure will hereinafter be described in conjunction with the following drawing figures, wherein like numerals denote like elements, and wherein:

FIG. 1 is a schematic perspective view of an electric vehicle with a cut-away section to reveal a battery housed in a battery enclosure in accordance with exemplary embodiments.

FIG. 2 is a perspective view of the battery of FIG. 1, in accordance with exemplary embodiments.

FIG. 3 is a cross-sectional schematic view of a portion of the battery of FIG. 2, in accordance with exemplary embodiments.

FIG. 4 is an overhead schematic view of the battery of FIG. 3.

FIGS. 5-9 are cross-sectional schematic views of a portion of the battery of FIG. 2, in accordance with exemplary embodiments.

FIG. 10 is a cross-sectional schematic view of a conductive region, in accordance with exemplary embodiments.

FIGS. 11 and 12 are cross-sectional schematic views of a battery of FIG. 2, in accordance with exemplary embodiments.

FIG. 13 is a cross-sectional schematic view illustrating a mating engagement between two features, in accordance with exemplary embodiments.

FIG. 14 is a flow chart illustrating a method for applying an electric potential to a battery enclosure in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments herein provide for applying a selected electrical potential onto a battery enclosure. For example, the electrical potential may be applied to the battery enclosure to improve corrosion resistance, i.e., prevent or delay corrosion. For battery cells with metal enclosures, the choice of enclosure potential (positive vs neutral vs negative) impacts the corrosion resistance. Further, embodiments herein ensure electrical isolation between the electrode assembly and the metallic enclosure, as shorting may cause an unintended high self-discharge (HSD) of the battery cell. In certain embodiments, the battery cell is a prismatic can battery cell and an isolation plastic insert plate is located between the electrode assembly and the enclosure cap.

Certain embodiments provide electrical isolation while achieving a desired metal enclosure potential through the addition of conductive filler to portions or the entirety of the insert plate without additional complexity during cell manufacturing by modifying the design of the insert plate.

Certain embodiments use a single insert plate with two or more integral regions of distinctly different electrical conductivities. In certain embodiments, an insert plate has two or more separate regions of distinctly different electrical conductivities. In such embodiments, the separate regions are provided with protruding elements and/or cutaway portions configured to mate with and engage one another.

Certain embodiments provide for heat bonding the insert plate to the metallic cap of the battery enclosure to ensure reliable contact. Certain embodiments provide for bonding the insert plate to the metallic cap of the battery enclosure through a combination of heat and pressure. Certain embodiments provide for fixing the insert plate to the metallic cap of the battery enclosure by engaging protruding elements or cutaway portions or snap features formed on the insert plate and the cap for mating engagement therebetween.

In certain embodiments, a battery cell assembly includes a cap plate isolation insert that provides an ohmic resistance between the enclosure and one of the cell internal bussing circuits. In such embodiments, a cap plate insert for a battery cell is located between the electrode foils or an internal weld plate and a portion of the enclosure and/or cap assembly. The cap plate insert comprises one or more regions including a conductive additive, such as carbon black to form conductive regions. As a result, the conductive regions are provided with a distinctly different conductivity as compared to cap plate insert regions which do not include a conductive additive. In certain embodiments, a conductive region of the cap plate insert is comprised of up to 30% by weight of the conductive additive.

In certain embodiments, a battery cell assembly includes at least two cap plate isolation inserts. In such embodiments, one of the inserts is partially or wholly comprised of a plastic resin containing up to 30% by weight of a conductive filler.

In certain embodiments, the conductive region within the insert plate does not enclose or surround any rivets or conductive pathways to the terminal. In certain embodiments, the conductive region within the insert plate does enclose or surround a rivet or conductive pathway to the terminal.

In certain embodiments, the conductive region within the insert plate extends completely from a bottom surface of the insert plate to a top surface of the insert plate. In other embodiments, the conductive region is located at the top surface of the insert plate and does not extend to the bottom surface of the insert plate.

In certain embodiments, a single terminal is located over the cap of the enclosure and the insert plate located under the cap is fully conductive, i.e., includes no insulative region.

Certain embodiments provides for obtaining a desired enclosure polarity independent of existing battery cell and component technology. Specifically, embodiments herein may utilize given battery cell components, established manufacturing methods, and materials already in use within production battery cells, introducing no unknown chemical compatibility risks, while still obtaining any desired enclosure polarity.

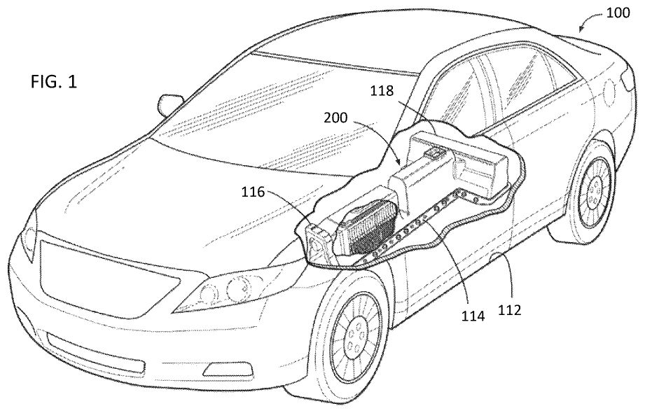

Referring to the drawings, wherein like reference numbers correspond to like or similar components wherever possible throughout the several figures, an electric vehicle 100 having a battery module 200, such as battery cell, or a plurality of battery cells in a battery assembly, is shown in FIG. 1. The term “battery” used alone herein may refer to a battery module, battery cell or cell stack. The term “battery pack” used alone may refer to a battery and the battery enclosure system the battery is housed within.

FIG. 1 illustrates the electric vehicle 100 as an automobile, such as any one of a number of different types of automobiles, such as, for example, a sedan, a wagon, a truck, sport utility vehicle (SUV), or the like. In certain implementations, the vehicle 100 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the battery module 200 may instead be part of and/or coupled to any number of other types of platforms and/or other systems, moving or non-moving, such as a building, infrastructure, secondary use, home power, non-automotive, and/or other platforms and/or other systems.

The illustrated electric vehicle 100 includes a vehicle chassis 112. The battery module 200 is provided with a battery tray 114. The battery module 200 may attach to the battery tray 114, which in turn, may attach to the vehicle chassis 112 to secure the battery module 200 to the electric vehicle 100.

The electric vehicle 100 may also include a battery disconnect unit 116, which is connected to the battery 200 and provides electrical communication between the battery 200 and an electrical system (not shown) of the electric vehicle 10.

The battery module 200 is further provided with a battery cover 118 that extends over and around the battery 200. The battery cover 118 may protect the battery 200 from being damaged, as well as provide electrical insulation to the high voltage of the battery 200.

In exemplary embodiments, battery module 200 is an assembly of battery cells.

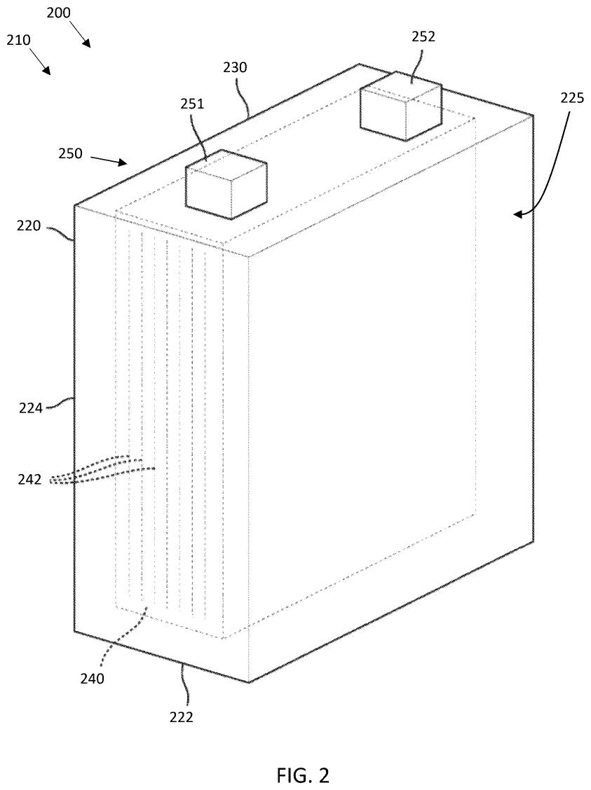

FIG. 2 schematically illustrates in perspective view of a battery cell 210 of the battery module 200 of FIG. 1. Specifically, FIG. 2 illustrates a prismatic battery cell 210.

The prismatic battery cell 210 is illustrated as including an outer case or enclosure 220 that surrounds and defines an internal space 225 within the enclosure 220. An exemplary outer enclosure 220 may be conductive. For example, the outer enclosure 220 may be metallic. In certain embodiments, the enclosure 220 is aluminum. The illustrated outer enclosure 220 is a rectangular polyhedron and includes relatively short side opposite faces 222 and relatively long side opposite faces 224.

As shown, the outer enclosure 220 may be formed with an open end, which is covered or closed by a cap 230. In certain embodiments, the cap 230 may be part of the enclosure 220. In certain embodiments, the cap 230 is conductive. For example, the cap 230 may be metallic, such as aluminum or aluminum alloy.

As shown, the battery cell 210 may include tabs or terminals 250, including a first tab or terminal 251, and an optional second tab or terminal 252. Each terminal 251, 252 may be in electrical connection with the battery cell components within the outer enclosure 220. In certain embodiments, each terminal 251, 252 is insulated from the cap 230.

In certain embodiments, the battery cell 210 includes an electrode assembly 240. As shown, the electrode assembly 240 is illustrated with dashed lines, indicating the electrode assembly 240 as a component of the prismatic battery cell 210 that is internal to the hard outer enclosure 220, i.e., located within the internal space 225. The electrode assembly 240 is illustrated with a plurality of electrode pair layers 242 arranged such that planar surfaces of the electrode pair layers 242 are perpendicular to the short faces 222.

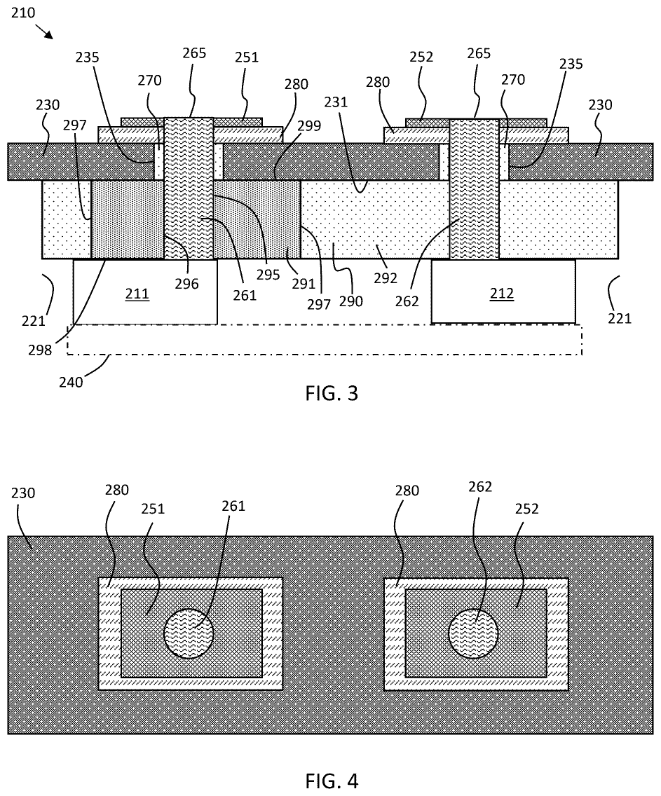

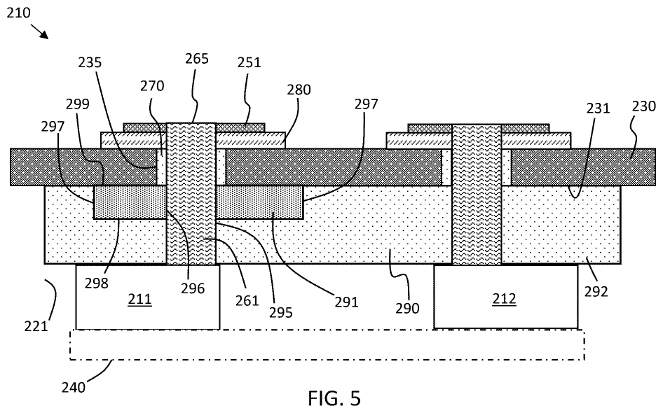

FIG. 3 is a cross-sectional schematic of the battery cell 210 of FIG. 2. In FIG. 3, certain internal components of the battery cell 210 are illustrated. FIG. 4 is an overhead view of the battery cell 210 of FIG. 3.

As shown in FIG. 3, the battery cell 210 includes a conductive first structure 211 and a conductive second structure 212. Each structure 211, 212 is in electrical connection with the electrode assembly 240 of FIG. 2. For example, structure 211 may be a cathode plate and structure 212 may be an anode plate. Alternatively, structure 211 may be an anode plate and structure 212 may be a cathode plate. Structures 211, 212 may be aluminum or copper. For example, an anode plate may be copper and a cathode plate may be aluminum. In other embodiments, each structure 211, 212 is an electrode foil in electrical connection with the electrode assembly 240 and/or with an internal bussing circuit in electrical connection with the electrode assembly 240.

Structure 211 may be electrically connected to a conductive rivet or connector 261, and structure 212 may be electrically connected to a conductive rivet or connector 262. For example, structure 211 may abut conductive rivet or connector 261, and structure 212 may abut conductive rivet or connector 262 as shown.

As shown in FIG. 3, the cap 230 may be formed with openings 235. Further, each connector 261, 262 may extend through a respective opening 235 and through the cap 230 to a distal end 265.

FIG. 3 further illustrates that the battery cell 210 is provided with an insulator spacer or sleeve 270 located in each opening 235. The insulator sleeves 270 insulate the cap 230 from each respective connector 261, 262.

Cross referencing FIGS. 3 and 4, the distal end 265 of connector 261 is electrically to terminal 251 and the distal end 265 of connector 262 is electrically to terminal 252. The battery cell 210 is provided with insulator plates 280 located over the cap 230. The insulator plates 280 insulate the cap 230 from each respective terminal 251, 252. Insulator plates 280 may be ceramic.

As shown in FIG. 3, an insert 290 is provided between the cap 230 and the structures 211, 212. In certain embodiments, the insert 290 is non-rigid. For example, insert 290 may be compressible. In certain embodiments, insert 290 is malleable and/or deformable. In certain embodiments, insert 290 is formed from thermoplastic resin. For example, insert 290 may be comprised of polypropylene.

As shown in FIG. 3, insert 290 contacts an underside 231 of the cap 230. As shown, insert 290 also contacts cathode/anode structures 211, 212. In certain embodiments, insert 290 is compressed between cap 230 and cathode/anode structures 211, 212.

As shown, insert 290 includes a first region 291 and a second region 292. In certain embodiments, region 291 is conductive and region 292 is insulative. For example, region 291 has a distinctly different conductivity from region 292. In certain embodiments, region 291 has a conductivity that is at least 1.5 times greater than the conductivity of region 292. In certain embodiments, region 291 has a conductivity that is at least 2 times greater than the conductivity of region 292, such as at least 3 times, at least 5 times, or at least 10 times greater than the conductivity of region 292.

Thus, region 291 of insert 290 provides electrical connection between the structure 211 and the enclosure 220. Further, region 291 of insert 290 provides electrical connection between the connector 261 and the enclosure 220. Region 292 of insert 290 insulates the enclosure 220 from the structure 212 and insulates the enclosure 220 from the connector 262. Specifically, region 292 of insert 290 provides an ohmic resistance between the cap 230 and the electrode assembly 240 and/or internal bussing circuit.

In certain embodiments, region 292 is comprised of a thermoplastic resin, such as polypropylene, and region 291 is comprised of the same thermoplastic resin, i.e., polypropylene, and a conductive additive, such as carbon black.

As a result of the electrical connection from structure 211 and connector 261 to cap 230, an electric potential may be applied to the cap 230 and enclosure 220 from the electrode assembly 240. Further, embodiments herein provide for applying a selected electric potential to the enclosure 220. For example, given known electrical properties of the battery cell 120 and of the charge on structure 211, region 291 may be provided with a selected conductivity to apply the selected electric potential to the enclosure 220.

In certain embodiments, region 291 is formed with the selected conductivity by forming region 291 from the thermoplastic resin and from a conductive additive. For example, the conductive additive may be carbon black. In certain embodiments, region 291 consists of the thermoplastic resin and the conducive additive. In certain embodiments, region 291 is comprised of up to 30 weight percent of the conductive additive, based on a total weight of the region 291. For example, region 291 may be comprised of up to 25, 20, 15, 10, or 5 weight percent of the conductive additive, based on a total weight of the region 291. In certain embodiments, region 291 may be comprised of at least 1 weight percent of the conductive additive, such as at least 2, at least 5, at least 10, at least 15, at least 20, or at least 25 weight percent of the conductive additive, based on a total weight of the region 291.

In the embodiment of FIG. 3, insert 290 be a unitary piece including both region 291 and region 292, which are integral with one another. For example, insert 290 may be formed from a thermoplastic resin, and the conductive additive may be added to region 291. In such an embodiment, region 292 is wholly comprised of a thermoplastic resin and region 291 is partially comprised of the same thermoplastic resin. Insert 290 may be formed by injection molding and the conductive additive may be added to the thermoplastic resin in the desired region 291 before the injection molding process.

Alternatively, in the embodiment of FIG. 3, regions 291 and 292 may be separate pieces. In such an embodiment, region 291 may consist of a conductive material or may consist essentially of a conductive material. Further, in such an embodiment, region 291 may not share any compositional component with region 292. Alternatively, separately formed region 292 may be wholly comprised of a thermoplastic resin and separately formed region 291 may be partially comprised of the same thermoplastic resin.

In the embodiment of FIG. 3, region 291 has a bottom surface 298 that abuts and directly contacts the structure 211. Further, region 291 has a top surface 299 that abuts and directly contacts the cap 230 (and the insulator sleeve 270). Also, region 291 has an outer surface or surfaces 297 that contacts the insulative region 292. As further shown, region 291 is surrounded at outer surfaces 297 by the insulative region 292.

In FIG. 3, region 291 is formed with opening 295 and has an inner surface or surfaces 296 that define the opening 295. As shown, the connector 261 extends through the opening 295 such that the inner surfaces 296 of region 291 contact the connector 261.

In the embodiment of FIG. 3, an electric potential may be applied from the structure 211 to the enclosure 220 by passing directly from the structure 211 to the bottom surface 298 of region 291 and from the top surface 299 directly to the cap 230 and then to the enclosure 220. Further, an electric potential may be applied from the structure 211 to the enclosure 220 by passing directly from the connector 261 to the inner surface 296 of region 291 and from the top surface 299 directly to the cap 230 and then to the enclosure 220.

FIG. 5 illustrates an alternate embodiment of the battery cell 210 of FIG. 3. Specifically, region 291 is provided with an alternate structure. As shown in FIG. 5, region 291 has a top surface 299 that abuts and directly contacts the cap 230 (and the insulator sleeve 270). However, in the embodiment of FIG. 5, region 291 has a bottom surface 298 that does not abut or directly contacts structure 211. Rather, a portion of insulative region 292 is located below bottom surface 298. In other words, the insulative region 292 is located between bottom surface 298 and structure 211.

As shown, region 291 has an outer surface or surfaces 297 that contacts the insulative region 292. As further shown, region 291 is surrounded at outer surfaces 297 by the insulative region 292.

In FIG. 5, region 291 is formed with opening 295 and has an inner surface or surfaces 296 that define the opening 295. As shown, the connector 261 extends through the opening 295 such that the inner surfaces 296 of region 291 contact the connector 261. In FIG. 5, opening 295 is also defined by the portion of insulative region 292 under bottom surface 298.

In the embodiment of FIG. 5, an electric potential may be applied from the structure 211 to the enclosure 220 by passing directly from the connector 261 to the inner surface 296 of region 291 and from the top surface 299 directly to the cap 230 and then to the enclosure 220. There is no electrical path directly from the structure 211 to the bottom surface 298 of region 291.

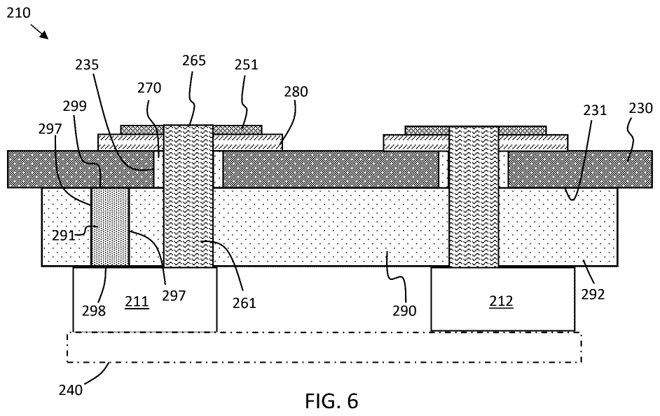

FIG. 6 illustrates an alternate embodiment of the battery cell 210 of FIG. 3. Specifically, region 291 is provided with an alternate structure. As shown in FIG. 6, region 291 has a bottom surface 298 that abuts and directly contacts the structure 211. Further, region 291 has a top surface 299 that abuts and directly contacts the cap 230 (and the insulator sleeve 270). Also, region 291 has an outer surface or surfaces 297 that contacts the insulative region 292. As further shown, region 291 is surrounded at outer surfaces 297 by the insulative region 292.

In the embodiment of FIG. 6, region 291 is not formed with an opening. Further region 291 does not abut or directly contact connector 261. Rather, the nearest outer surface 297 is distanced from the connector 261, such that a portion of the insulative region 292 is located between region 291 and connector 261.

In the embodiment of FIG. 6, an electric potential may be applied from the structure 211 to the enclosure 220 by passing directly from the structure 211 to the bottom surface 298 of region 291 and from the top surface 299 directly to the cap 230 and then to the enclosure 220. There is no electrical path from the connector 261 directly to the region 291.

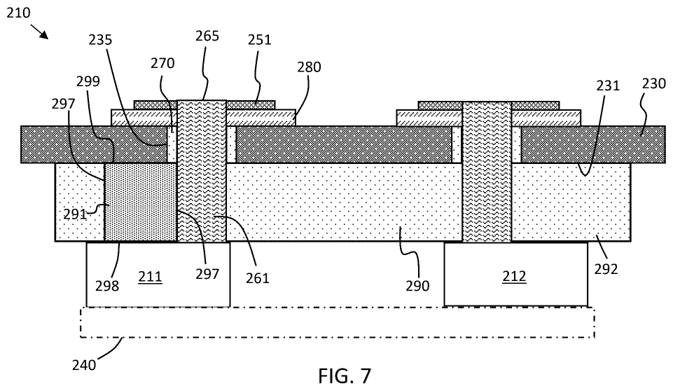

FIG. 7 illustrates an alternate embodiment of the battery cell 210 of FIG. 3. Specifically, region 291 is provided with an alternate structure. As shown in FIG. 7, region 291 has a bottom surface 298 that abuts and directly contacts the structure 211. Further, region 291 has a top surface 299 that abuts and directly contacts the cap 230 (and the insulator sleeve 270). Also, region 291 has an outer surface 297 that contacts the insulative region 292. As further shown, region 291 has an outer surface 297 that abuts or directly contacts connector 261. In the embodiment of FIG. 6, region 291 is not formed with an opening.

In the embodiment of FIG. 7, an electric potential may be applied from the structure 211 to the enclosure 220 by passing directly from the structure 211 to the bottom surface 298 of region 291 and from the top surface 299 directly to the cap 230 and then to the enclosure 220. Further, an electric potential may be applied from the structure 211 to the enclosure 220 by passing directly from the connector 261 to the outer surface 297 of region 291 and from the top surface 299 directly to the cap 230 and then to the enclosure 220.

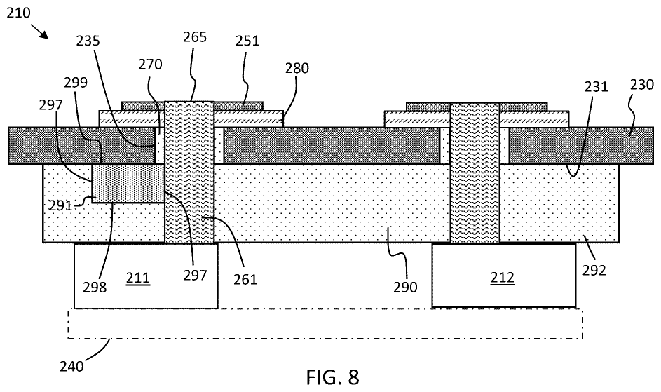

FIG. 8 illustrates an alternate embodiment of the battery cell 210 of FIG. 3. Specifically, region 291 is provided with an alternate structure. As shown in FIG. 8, region 291 has a top surface 299 that abuts and directly contacts the cap 230 (and the insulator sleeve 270). However, in the embodiment of FIG. 8, region 291 has a bottom surface 298 that does not abut or directly contacts structure 211. Rather, a portion of insulative region 292 is located below bottom surface 298. In other words, the insulative region 292 is located between bottom surface 298 and structure 211.

Also, region 291 has an outer surface 297 that contacts the insulative region 292. As further shown, region 291 has an outer surface 297 that abuts or directly contacts connector 261. In the embodiment of FIG. 8, region 291 is not formed with an opening.

In the embodiment of FIG. 8, an electric potential may be applied from the structure 211 to the enclosure 220 by passing directly from the connector 261 to the outer surface 297 of region 291 and from the top surface 299 directly to the cap 230 and then to the enclosure 220. There is no electrical path directly from the structure 211 to the bottom surface 298 of region 291.

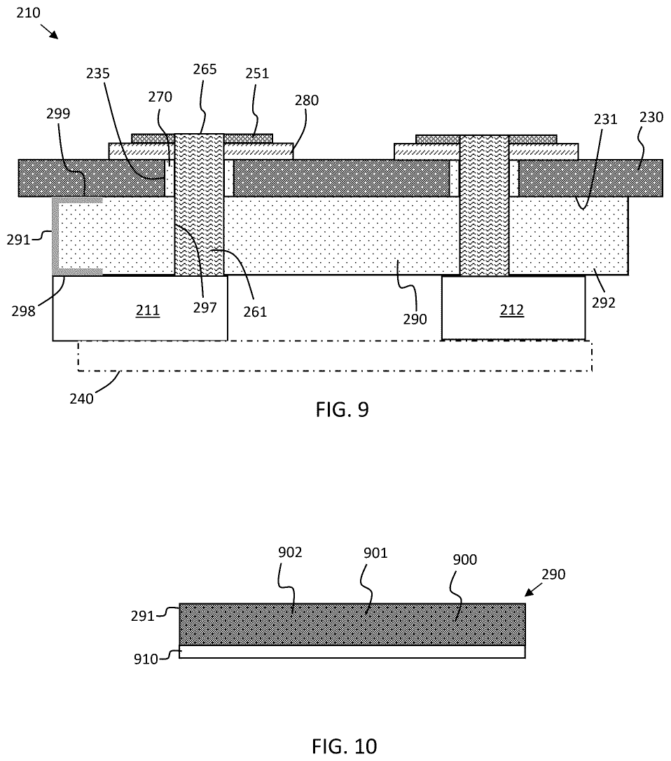

FIG. 9 illustrates another embodiment of battery cell 210. In FIG. 9, region 291 may be formed on outer surfaces of the insert 290. For example, region 291 may be formed from a tape segment, i.e., a substrate including the conductive additive that is adhered to the insert 290 by an adhesive layer.

In the embodiment of FIG. 9, an electric potential may be applied from the structure 211 to the enclosure 220 by passing directly from the structure 211 to the bottom surface 298 of region 291 and from the top surface 299 directly to the cap 230 and then to the enclosure 220. There is no electrical path directly from the connector 261 to the cap 230.

FIG. 10 illustrates an insert 290 comprising a conductive region 291 including a layer 900 of thermoplastic resin 901 in which a conductive additive 902 is dispersed or infused. As shown, an adhesive layer 910 is applied to layer 900. The insert 290 may be used in the embodiment of FIG. 9. Alternatively, layer 900 may be provided without adhesive layer 910 and may be formed as the conductive region 291 in the embodiments of FIGS. 3-8.

Conductive region 291 may be formed in a molding process from a thermoplastic resin 901 and a conductive additive 902. For example, an injection molding method may be performed and may include injecting a flowable polymeric material and an electrically conductive additive into a first mold and solidifying the flowable polymeric material to form the conductive region 291. The insulative region 292 may be formed in the same process in an area where no conductive additive 902 is added. In such an embodiment, the regions 291 and 292 are physically and chemically bonded together. Alternatively, the conductive region 291 and insulative region 292 may be formed separately and joined together when bonded to the cap 230.

The embodiments above describe a battery cell 210 in which the terminals 251, 252 are provided on a common end. In other embodiments, the terminals 251, 252 may be provided on opposite ends of the battery cell 210.

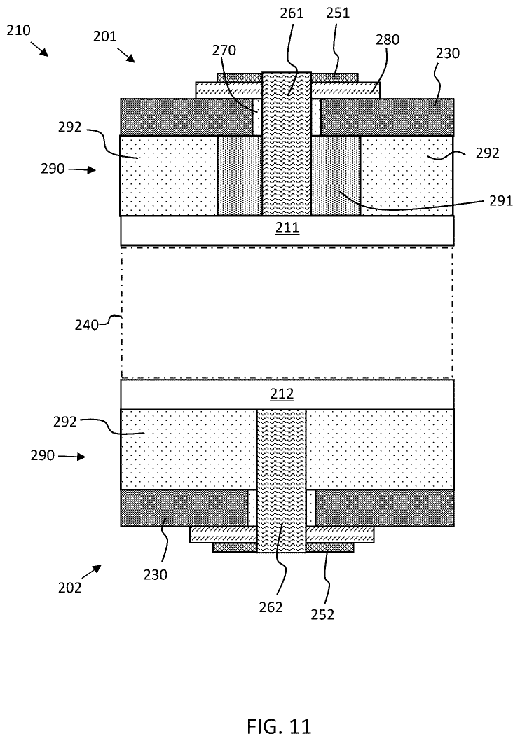

For example, FIG. 11 illustrates such an embodiment. As shown in FIG. 11, battery cell 210 has a first end 201 and a second end 202. Each end 201, 202 includes a cap 230. Structure 211 is interconnected to terminal 251 by connector 261 at the first end 201, and structure 212 is interconnected to terminal 252 by connector 262 at the second end 202.

As shown, an insert 290 is located at the first end 201 between the structure 211 and the cap 230. The insert 290 at the first end 201 includes a conductive region 291 and an insulative region 292. At end 202, the insert 290 includes only an insulative region 292.

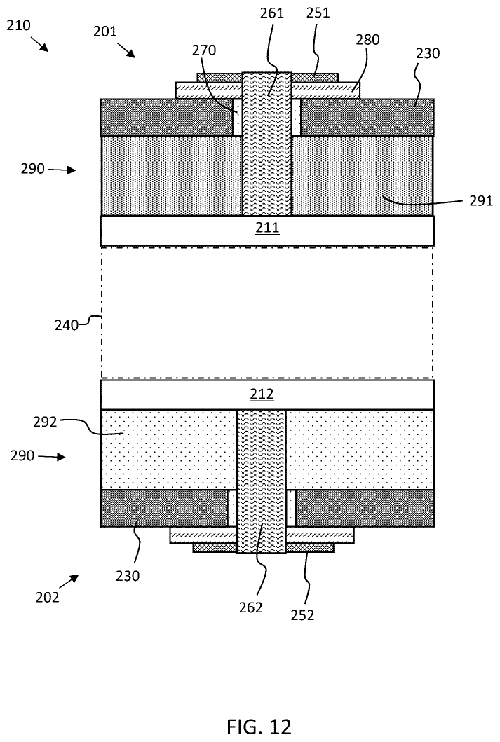

FIG. 12 illustrates another embodiment of a battery cell 210 having terminals 251, 252 at opposite ends 201, 202. In FIG. 12, the insert 290 at end 201 includes only a conductive region 291, while the insert 290 at end 202 includes only an insulative region 292.

While FIGS. 11 and 12 illustrate certain embodiments of a battery cell 210 having terminals 251, 252 at opposite ends 201, 202, other embodiments are contemplated. For example, the insert 290 and conductive region 291 of end 201 may be provided with any structure or feature of a structure as described above in relation to FIGS. 3-8.

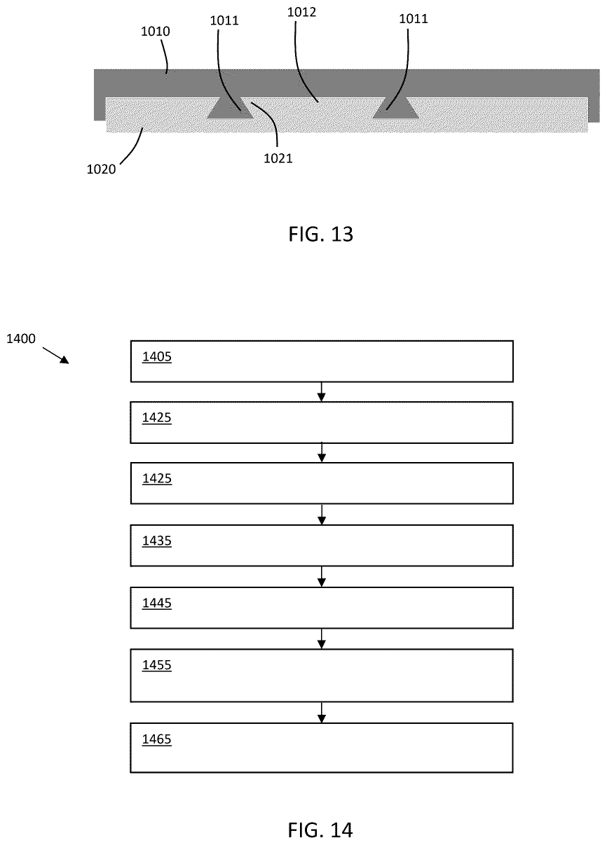

FIG. 13 illustrates a mating engagement between two elements that may be used in embodiments herein. As shown, a first element 1010 includes a first mating feature 1011 and a second element 1020 includes a second mating feature 1021. As shown, the mating features 1011 and 1021 provide for engagement of the second element 1020 to the first element 1010.

In certain embodiments herein, the first element 1010 may be the cap 230 and the second element may be the insert 290 or the region 291 of the insert 290.

For example, the mating features 1011 may be adjacent projections that define a cutaway portion or recess 1012 therebetween. Further, the mating feature 1021 may be projection that is received within the recess 1012.

In certain embodiments, the region 291 of the insert 290 may be snap fit into engagement with the cap 230, such as by engagement of mating features 1011 and 1021.

In certain embodiments, the region 291 of the insert 290 may be heat bonded into engagement with the cap 230. During heat bonding, the region 291 of the insert 290 may be deformed and pressed into contact with the cap 230, thereby increasing contact therebetween. Specifically, air pockets between the insert 290 and the cap 230 are reduced or eliminated. The heating bonding process may be performed by locating the insert 290 adjacent to the underside 231 of the cap 230 and then pressing the insert 290 into contact with the underside 231 of the cap 230. Specifically, a heated element such as a rod may be pushed into the insert 290. Other embodiments may use other structures to apply a combination of heat and pressure to connect the insert 290 and cap 230.

As a result of maximizing the physical contact area between the region 291 and the cap 230, sufficient electrical contact may be established throughout the lifetime of the battery cell 210.

In certain embodiments herein, the first element 1010 may be conductive region 291 and the second element 1020 may be insulative region 292. Specifically, when regions 291 and 292 are formed separately, they may be snap fit or otherwise fixed together by joining and/or engaging the mating features 1011 and 1021.

Referring now to FIG. 14, a method 1400 for applying a potential to a battery enclosure is described.

Method 1400 includes, at operation 1405, providing a battery enclosure, a cap or cap plate for closing the enclosure, battery terminals, and insulator elements.

At operation 1415, method 1400 includes determining the properties of a conductive region that will provide for applying a desired electric potential to the battery enclosure. Operation 1415 may include selecting a desired electric potential to be applied to the enclosure. Further, because the dimensions and conductivity of the various enclosure structures are known, and the charge at each battery electrode is known, the conductive region of the insert may be designed with a specific conductivity and with specific contact areas to apply the desired electric potential to the enclosure.

At operation 1425, method 1400 includes forming an insert by adding a conductive additive to a plastic resin in accordance with the properties determined at operation 1415. For example, a single one-piece unitary insert may be formed by molding the insert from a thermoplastic resin and adding a conductive additive to a portion where the conductive region is to be formed. In other embodiments, the insert is formed by first forming a conductive region and an insulative region and then by fixing the conductive region and the insulative region together. A desired conductivity of the conductive region may be obtained by selecting the amount of conductive additive provided in the conductive region.

At operation 1435, method 1400 includes fitting the insert to the cap. For example, operation 1435 may include heat bonding, snap fitting, or press fitting the insert into engagement with the cap. Operation 1435 may include deforming the insert and reducing or eliminating any air pockets located between the insert and the cap.

At operation 1445, method 1400 includes enclosing a first electrode, and a second electrode within the enclosure. Operation 1445 may include locating the insert between the electrodes and the enclosure. For example, the cap may be fixed to the enclosure, with the insert on the internal surface of the cap.

At operation 1455, method 1400 includes electrically connecting the first electrode to a first terminal and electrically connecting the second electrode to a second terminal.

Operation 1465 of method 1400 includes establishing an electrical connection from the from the first electrode through the conductive region, wherein the electrical connection is configured to apply a potential to the enclosure. Operation 1465 may include applying the desired potential to the enclosure from the first electrode through the conductive region.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
enclosing a first electrode and a second electrode within an enclosure;
electrically connecting the first electrode to a first terminal;
electrically connecting the second electrode to a second terminal;
locating an insert between the electrodes and the enclosure, wherein the insert includes a conductive region electrically connecting the first electrode to the enclosure, and wherein the insert includes an insulative region electrically insulating the first electrode from the enclosure; and
establishing an electrical connection from the from the first electrode through the conductive region, wherein the electrical connection is configured to apply a potential to the enclosure.

2. The method of claim 1, further comprising forming the insert by adding a conductive additive to a plastic resin.

3. The method of claim 2, wherein the conductive region is comprised of up to 30% of the conductive additive by weight.

4. The method of claim 3, further comprising:
electrically connecting, through a first connector, the first electrode to the first terminal; and
abutting the conductive region with the enclosure and with the first connector.

5. The method of claim 3, wherein the conductive additive comprises carbon black.

6. The method of claim 3, further comprising:
electrically connecting, through a first connector, the first electrode to the first terminal; and
abutting the conductive region with the enclosure, with the first connector, and with the first electrode.

7. The method of claim 2, wherein the insert is deformable, and wherein locating the insert between the electrodes and the enclosure comprises deforming the insert.

8. A battery assembly comprising:
an enclosure surrounding an internal space;
a first electrode located in the internal space;
a second electrode located in the internal space;
a first connector in electrical connection with the first electrode and extending out of the enclosure to a distal end;
a second connector in electrical connection with the second electrode and extending out of the enclosure to a distal end;
a first terminal in electrical connection with the distal end of the first connector;
a second terminal in electrical connection with the distal end of the second connector;
a conductive region electrically connecting the first electrode to the enclosure and configured to apply a potential to the enclosure; and
an insulative region electrically insulating the first electrode from the enclosure.

9. The battery assembly of claim 8, wherein the conductive region comprises a conductive tape segment adhered to the insulative region.

10. The battery assembly of claim 8, wherein the battery assembly comprises an insert located between the enclosure and the electrodes, wherein the insert is deformable, and wherein the insert includes the conductive region electrically connecting the first electrode to the enclosure and the insulative region.

11. The battery assembly of claim 10, wherein the conductive region of the insert comprises a plastic resin and a conductive additive.

12. The battery assembly of claim 11, wherein the conductive region of the insert comprises a plastic resin and a conductive additive, and wherein the conductive region is comprised of up to 30% of the conductive additive by weight.

13. The battery assembly of claim 12, wherein the conductive additive comprises carbon black.

14. The battery assembly of claim 11, wherein the conductive region abuts the enclosure and the first connector, abuts the enclosure and the first electrode, or abuts the enclosure, the first connector, and the first electrode.

15. A vehicle comprising:
an electric motor configured to provide motive torque; and
a battery system operatively connected to the electric motor and operable to provide electrical power to the electric motor, wherein the battery system comprises:
an enclosure surrounding an internal space;
a first electrode located in the internal space;
a second electrode located in the internal space;
a first connector in electrical connection with the first electrode and extending out of the enclosure to a distal end;
a second connector in electrical connection with the second electrode and extending out of the enclosure to a distal end;
a first terminal in electrical connection with the distal end of the first connector;
a second terminal in electrical connection with the distal end of the second connector; and
an insert located between the enclosure and the electrodes, wherein the insert includes a conductive region electrically connecting the first electrode to the enclosure and configured to apply a potential to the enclosure, and wherein the insert includes an insulative region electrically insulating the first electrode from the enclosure.

16. The vehicle of claim 15, wherein the conductive region of the insert comprises a plastic resin and a conductive additive.

17. The vehicle of claim 16, wherein the conductive region is comprised of up to 30% of the conductive additive by weight.

18. The vehicle of claim 16, wherein the conductive additive comprises carbon black.

19. The vehicle of claim 15, wherein the conductive region abuts the enclosure and the first connector.

20. The vehicle of claim 15, wherein the conductive region abuts the enclosure and the first electrode.
